(19) United States
(12) Patent Application Publication
(10) Pub. No.: US 2025/0250689 A1
(43) Pub. Date: Aug. 7, 2025

(54) ELECTRODIALYSIS SALT SPLITTING REGENERANT GENERATION FOR WAC AND WBA RESIN COMBINED WITH SODIUM HYPOCHLORITE ON-SITE GENERATION PROCESS

(71) Applicants: Stephen M. Mosher, Chandler, AZ (US); Christopher J. Bellizi, Lake Forest, CA (US)

(72) Inventors: Stephen M. Mosher, Chandler, AZ (US); Christopher J. Bellizi, Lake Forest, CA (US)

(21) Appl. No.: 19/019,297

(22) Filed: Jan. 13, 2025

Related U.S. Application Data
(63) Continuation of application No. 17/523,744, filed on Nov. 10, 2021, now abandoned.
(60) Provisional application No. 63/112,524, filed on Nov. 11, 2020.

(51) Int. Cl. C25B 1/34

(52) U.S. Cl. CPC C25B 1/34

(57) ABSTRACT

Disclosed is a combined generator technology for two purposes: 1) electrodialysis “salt splitting” (ESS) to convert sodium chloride salt into an acid (hydrochloric or sulfuric) and a caustic (sodium hydroxide) to be generated for use as regeneration solutions for weak acid cation, weak base anion, and strong base anion resin systems and 2) electro-generation for converting sodium chloride salt into an aqueous solution of sodium hypochlorite both with the intention of treating make up water and/or recirculating in a cooling tower, fluid cooler, or any evaporative cooling device; other salts will apply to the process in addition to sodium chloride (example sodium sulfate).

### BACKGROUND OF THE APPLICATION AND INVENTION

This application claims the benefit of U.S. Nonprovisional application Ser. No. 17/523,744, filed Nov. 11, 2021, which in turn claims priority to U.S. Provisional Application No. 63/112,524 filed Nov. 11, 2020, the entire contents of which applications are hereby incorporated by reference

Weak acid cation (WAC) and weak base anion (WBA) resins (and strong base anion) have been in use for decades. The use of these resins is ideal in that they specifically target the removal of the majority of water efficiency robbing ions in water such as hardness, alkalinity, chlorides, and sulfates. These resins utilize an acid and base respectively to regenerate the resin for repeated use. Typical acids are either hydrochloric acid or sulfuric acid. Typical caustic solutions are sodium hydroxide and potassium hydroxide. These chemicals are supplied via chemical drums to the site which costs a lot of money to manufacture and deliver to the site. Additionally, the handling and transfer of these chemicals is considered very dangerous.

### BRIEF DESCRIPTION OF DRAWINGS

Features and advantages of the disclosure will readily be appreciated by persons skilled in the art from the following detailed description when read in conjunction with the drawing wherein:

FIG. 1 illustrates an exemplary embodiment of an electrolytic salt splitter (ESS) with a liquid chlorine generator.

FIG. 2 is a schematic block diagram of an ESS, WAC and WBA generator to produce sodium hypochlorite solution.

FIG. 3 is a schematic diagram of a further embodiment, an ESS, WAC, WBA generator to produce hypobromous acid solution.

FIG. 4 illustrates in schematic form a system for addressing system corrosion utilizing the systems of FIGS. 2 and 3.

### DETAILED DESCRIPTION OF THE INVENTION

The figures are not to scale, and relative feature sizes may be exaggerated for illustrative purposes.

On site production of the chemicals can be accomplished through the use of an electrodialysis “salt splitter” which applies electrical current to a brine solution consisting of a salt (typically sodium chloride) and water. This electrodialysis process “splits” the salt into hydrochloric acid and sodium hydroxide very efficiently and cost effectively. An example of the ESS process chemical equation is shown below:

H2O+NaCl->NaOH+HCl

A benefit of producing these products on site includes improved safety from delivering a food grade, non-hazardous product (salt, i.e. sodium chloride) as the primary reactant so the safety risk is greatly improved. Another benefit is the cost to produce the acid and base on site is far more cost effective than traditional off-site manufacturing plus delivery charges. The electrodialysis salt splitter (ESS) utilizes approximately 40-50% of the same components that are also used in the manufacturing of on-site generators (OSG) of liquid and gaseous chlorine chemistry. This results in generating a sodium hypochlorite solution that can be used as a disinfectant in the water stream thus controlling microbial contamination. When combined into the same system, the sodium hypochlorite generator can be manufactured more cost effectively by utilizing several of the shared components used in the electrodialysis salt splitter. These two technologies combined into the same piece of equipment can optimize the pretreatment of water in a method that is ideal for optimal water efficiency in evaporative cooling processes. Overall, the combined process improves safety, reduces handling and human exposure to hazardous chemicals, and reduces the operating cost of the resin regeneration and oxidant producing processes.

An example of the chlorine gas generation chemical equation is shown below:

\textcircled{1} Anode (oxidation): 2Cl-→Cl2+2e-

\textcircled{2} Cathode (reduction): 2H2O+2e-→H2+20H-

\textcircled{1}+\textcircled{2} (combined) 2Cl-+2H2O→Cl2+H2+2OH-

For Sodium Hypochlorite production, the chemical equation is shown below:

Cl2+2NaOH→NaCl+NaOCl

Faraday's Law

\textcircled{1}+\textcircled{2} (combined) 2Cl-+2H2O→Cl2+H2+20H-

In an electrochemical reaction, the number of moles of a substance formed is proportional to the number coulombs consumed. Faraday's constant is 26.80 A·h/mol.

Therefore, if we control the current to an electrolytic cell and there are no side reactions, we know how much of a reaction product is formed.

1 Anode (oxidation): 2Cl-→Cl2+2e-

2 moles of e-=53.6 A·h per mole Cl2 formed=53.6 A·h per 71 g Cl2 formed=1.32 g/A·h

Electrical efficiency is 90% so 1.19 g/A·h.

Cell Voltage=5 V. 5 W produces 1.19 g/hr

Power consumption=4.2 kWh/kg Cl2

2 moles Cl— required for 1 mole Cl2

2 moles NaCl required for 1 mole Cl2

116.88 g NaCl required for 71 g Cl2

1.65 g NaCl per g Cl2

Chemical efficiency is 82% so 2 g NaCl per g Cl2

Sodium chloride as 25% solution, sg=1.18=295 g/L. Need 2000 g NaCl per kg Cl2

So, 2000/295=6.78 L/kg Cl2

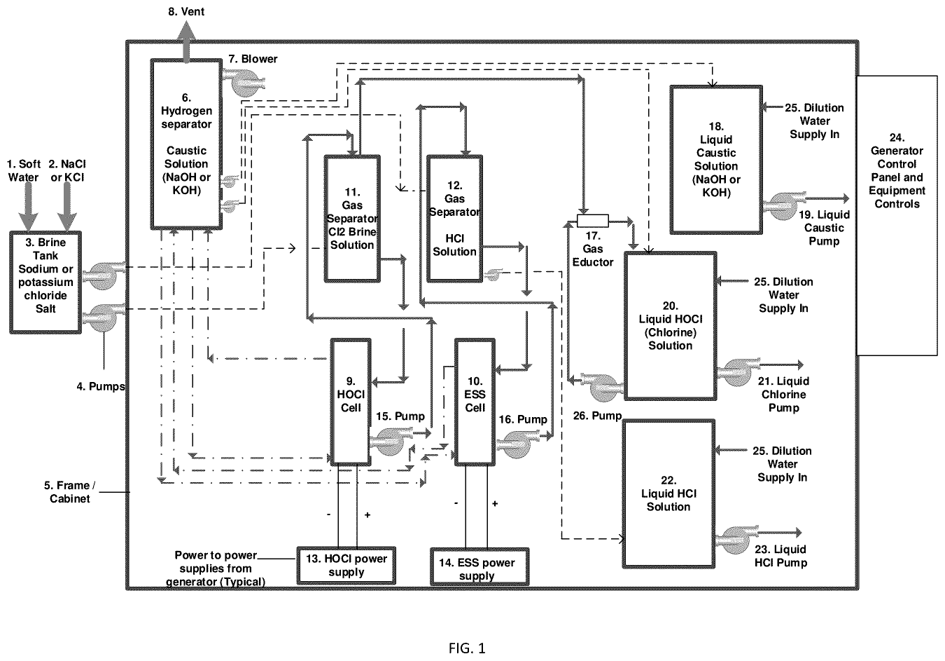

FIG. 1 illustrates an exemplary embodiment of an electrolytic salt splitter (ESS) with a liquid chlorine generator. The system includes the following components, according to the reference numbers noted in FIG. 1. Shared components are components that are used for dual tasks of salt splitting and chlorine production. Individual components are components that are only used for either salt splitting or chlorine production.
1 Soft Water supply (shared component)—This is the soft water make up supply used as the primary precursor for the reaction processes.
2. Sodium chloride or Potassium chloride salt (shared component)—this is the other component that forms the primary reaction precursor for the reaction processes.
3. Brine Tank Saturation system (shared component)—This tank is used to react the salt and water supply to create a saturated liquid brine solution that forms the primary reaction precursor for both chemical reactions.
4. Chemical brine pumps (individual components)—These pumps supply the precursor chemistry to the respective gas separator tanks.
5. Generator cabinet and frame (shared component)—This shared component refers to the frame and structural housing/cabinet that contains all necessary components.
6. Hydrogen Separator (shared component)—this gas separator separates out the hydrogen from the electrolytic process resulting in hydrogen release into the environment.
7. Blower motor (shared component)—this blower motor helps to strip the hydrogen out of the solution and blow the hydrogen out of the housing cabinet to maintain a safe concentration of hydrogen in the system. Hydrogen can be explosive, and this item ensures the concentration does not reach an explosive concentration point.
8. Vent line (shared component)—This vent provides the release channel for releasing hydrogen into the atmosphere (safely)
9. Hypochlorous acid cell (individual component)—This is the electrolytic reactor cell used to generate the chlorine gas molecule.
10. Salt splitter (ESS) cell (individual component)—This is the electrolytic reactor cell that splits the sodium chloride solution into an acid (hydrochloric acid) and a base (sodium hydroxide).
11. Chlorine gas separator (individual component)—this gas stripper column is used to strip the chlorine gas molecule out of solution and make it available to dissolve into the sodium hydroxide solution to form sodium hypochlorite.
12. Salt splitter gas separator/scrubber (individual component)—this gas separator strips out any low levels of gas (such as chlorine gas) from the electrolytic reaction process to form an acid solution (hydrochloric acid).
13. Hypochlorous acid electrical power supply (individual component)—This is the power supply source used to provide clean power to the hypochlorous acid electrolytic cell for the chemical reaction to take place.
14. Salt splitter (ESS) electrical power supply (individual component)—This is the power supply source used to provide clean power to the hydrochloric acid electrolytic cell for the chemical reaction to take place.
15. Chlorine anolyte pump (individual component)—this pump provides a pumping source to move the chlorine anolyte solution through the electrolytic cell and gas separation process.
16. Hydrochloric acid anolyte pump (individual component)—this pump provides a pumping source to move the acid anolyte solution through the electrolytic cell and gas separation process.
17. Chlorine gas eductor (individual component)—this component is a venturi eductor designed to inject the chlorine gas into the liquid solution under vacuum to form the sodium hypochlorite solution.
18. Liquid caustic storage tank (shared component)—this storage tank is used to store the liquid caustic generated from both processes.
19. Caustic Pump (individual component)—This pump is used to pump caustic for the intended downstream use process.
20. Liquid sodium hypochlorite solution storage tank (individual component)—This storage tank is used to store the liquid sodium hypochlorite solution to be used in the downstream process.
21. Liquid sodium hypochlorite solution pump (individual component)—This pump is used to pump the liquid sodium hypochlorite solution to be used in the downstream process.
22. Liquid hydrochloric acid storage tank (individual component)—This storage tank is used to store the liquid hydrochloric acid solution generated from the electrolytic process and to be used in the downstream process.
23. Liquid hydrochloric acid chemical pump (individual component)—This pump is used to pump the liquid hydrochloric acid solution to be used in the downstream process.
24. Generator controls panel and programmed logic controller (PLC) (shared component)—This component includes all the PLCs, human machine interface (HMI), electronics and controls components used to control both of the electrolytic processes.
25. Fresh water dilution water (shared component)—this water source is used to control the concentration of the chemical solution generated so it is not too concentrated or too dilute (it provides consistent concentration).
26. HOCL Recirculation pump—this equipment item is used to pump and recirculate finished HOCl solution thus educting the Chlorine gas into the liquid solution until the desired concentration is achieved.

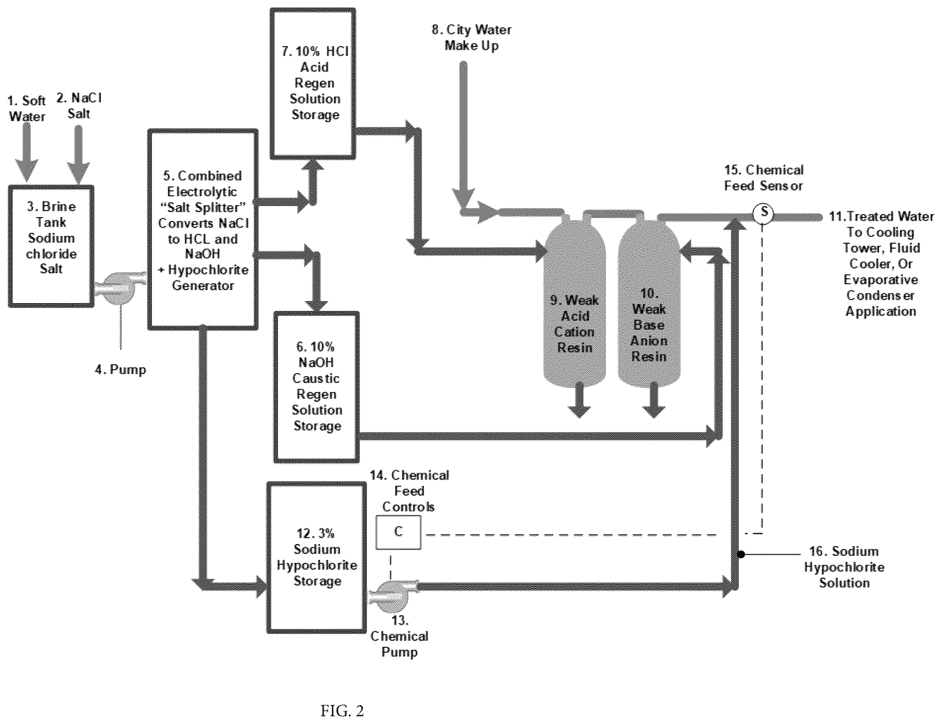

FIG. 2 is a schematic block diagram of an ESS, WAC and WBA generator to produce sodium hypochlorite solution. The generator includes the components within the cabinet/frame shown within border line 5 in FIG. 1. The components and their functions are described below.
1 Soft Water supply—This is the soft water make up supply used as the primary precursor for the reaction processes.
2. Sodium chloride or Potassium chloride salt—this is the other component that forms the primary reaction precursor for the reaction processes.
3. Brine Tank Saturation system—This tank is used to react the salt and water supply to create a saturated liquid brine solution that forms the primary reaction precursor for both chemical reactions.
4. Chemical brine pump—This pump supplies the precursor chemistry to the respective gas separator tanks.
5. Combination Electrolytic Salt Splitter and Sodium Hypochlorite generator—This shared component refers to the electrolytic generator process outlined in FIG. 1 as 5.
6. Liquid caustic storage tank—this storage tank is used to store the liquid caustic generated from the electrolytic processes.
7. Liquid hydrochloric acid storage tank—This storage tank is used to store the liquid hydrochloric acid solution generated from the electrolytic process and to be used in the downstream process.
8. City Water make up supply to resin tanks—this water source is the untreated source water that is to be treated and then used in the downstream process.
9. Weak Acid Cation Resin Tank—Weak acid cation resin used to remove hardness and alkalinity from the supply water source.
10. Weak Base Anion Resin Tank—Weak base anion resin used to remove sulfate and chloride ions from the water source.
11. Treated Water Effluent for use in downstream process—This is the final treated water to be used in downstream processes after being of an improved water quality.
12. Liquid sodium hypochlorite solution storage tank—This storage tank is used to store the liquid sodium hypochlorite solution to be used in the downstream process.
13. Liquid sodium hypochlorite solution pump—This pump is used to pump the liquid sodium hypochlorite solution to be used in the downstream process to act as a disinfectant.
14. Sodium hypochlorite chemical feed controls—These control components are used to proportionally control the liquid chemical sodium hypochlorite feed into the resin effluent treated water.
15. Sodium hypochlorite sensor—this sensor is used to either measure the active level of sodium hypochlorite in the water and adjust the feed rate accordingly, or it is used to feed chemical as a proportional control to water flow rate so that the feed of the sodium hypochlorite is applied in a controlled manner.
16. Sodium Hypochlorite Chemical Feed Line—This is the liquid sodium hypochlorite chemical feed supply line used to transport chemical from the storage tank to the treatment injection point.

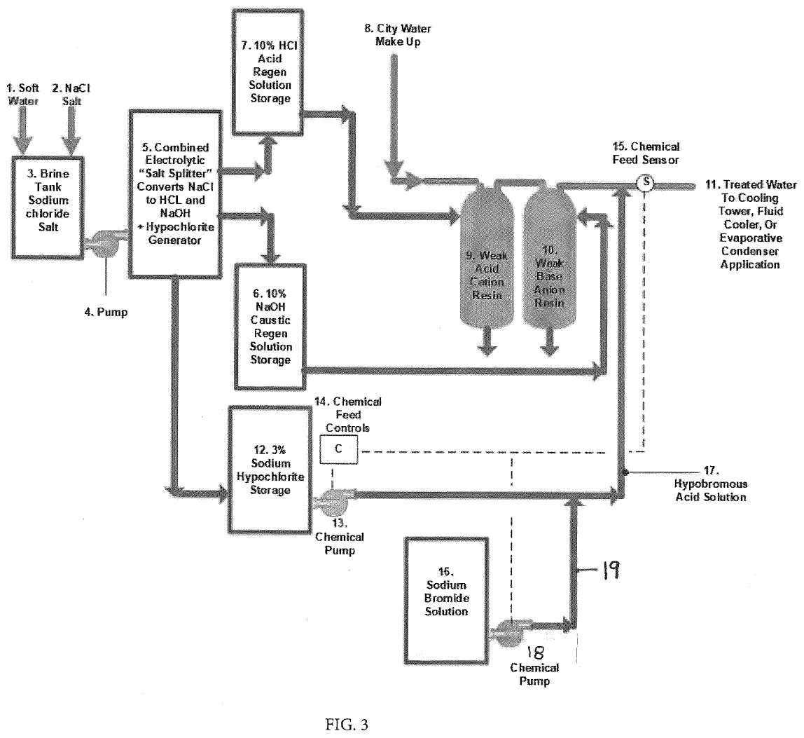

FIG. 3 is a schematic diagram of a further embodiment, an ESS, WAC, WBA generator to produce hypobromous acid solution. The generator includes the components within the cabinet/frame shown within border line 5 in FIG. 1. The components and their functions are described below.
1 Soft Water supply—This is the soft water make up supply used as the primary precursor for the reaction processes.
2. Sodium chloride or Potassium chloride salt—this is the other component that forms the primary reaction precursor for the reaction processes.
3. Brine Tank Saturation system—This tank is used to react the salt and water supply to create a saturated liquid brine solution that forms the primary reaction precursor for both chemical reactions.
4. Chemical brine pump—This pump supplies the precursor chemistry to the respective gas separator tanks.
5. Combination Electrolytic Salt Splitter and Sodium Hypochlorite generator—This shared component refers to the electrolytic generator process outlined in FIG. 1.
6. Liquid caustic storage tank—this storage tank is used to store the liquid caustic generated from the electrolytic processes.
7. Liquid hydrochloric acid storage tank—This storage tank is used to store the liquid hydrochloric acid solution generated from the electrolytic process and to be used in the downstream process.
8. City Water make up supply to resin tanks—this water source is the untreated source water that is to be treated and then used in the downstream process.
9. Weak Acid Cation Resin Tank—Weak acid cation resin used to remove hardness and alkalinity from the supply water source.
10. Weak Base Anion Resin Tank—Weak base anion resin used to remove sulfate and chloride ions from the water source.
11. Treated Water Effluent for use in downstream process—This is the final treated water to be used in downstream processes after being of an improved water quality.
12. Liquid sodium hypochlorite solution storage tank—This storage tank is used to store the liquid sodium hypochlorite solution to be used in the downstream process.
13. Liquid sodium hypochlorite solution pump—This pump is used to pump the liquid sodium hypochlorite solution to be used in the downstream process to act as a disinfectant.
14. Sodium hypochlorite chemical feed controls—These control components are used to proportionally control the liquid chemical sodium hypochlorite feed and the sodium bromide solution into the resin effluent treated water.
15. Sodium hypochlorite sensor—this sensor is used to either measure the active level of sodium hypochlorite in the water and adjust the feed rate accordingly, or it is used to feed chemical as a proportional control to water flow rate so that the feed of the sodium hypochlorite is applied in a controlled manner.
16. Liquid sodium bromide solution storage tank, used to store sodium bromide solution to be used in the downstream process.
17. Hypobromous Acid Chemical Feed Line—This is the liquid chemical feed supply line used to transport chemicals from the sodium hypochlorite and sodium bromide solution storage tanks to the treatment injection point.
18. Sodium bromide solution pump—This pump is used to pump the liquid sodium bromide solution to the feed line 17 be used in the downstream process to act as a disinfectant.

### Weak Acid Cation Resin System

Weak acid cation resin systems utilize a weak acid (or diluted strong acid) to regenerate the resin. Typical weak acid cation resins are spherical beads made from porous crosslinked polyacrylate. The process exchanges calcium and magnesium hardness ions, as well as alkalinity ions with hydrogen ions. The regeneration process follows the standard regeneration protocol of backwash, brine or regenerant draw cycle, slow rinse, and fast rinse. It is during the regenerant draw cycle that the 10% hydrochloric acid generated from the salt splitter is used to regenerate the resin. The electrodialysis salt splitter system generates 10% HCl based on a batch protocol to fill storage tanks which are designed to store the product produced for use as needed during the regeneration cycle. Typical concentration of acid used is between 2-4% active hydrochloric acid which is dosed into the regeneration process stream with a chemical pump proportional to make up flow rate for a time period of 30-120 minutes. The acid is applied at a rate of 1-2 GPM per cubic foot of resin during regeneration to ensure proper regeneration contact time. In the final 10% of the regenerant draw cycle, the resin is regenerated. As a result, the draw cycle waste water falls below the industrial waste water discharge limit of 5.0 pH for the remainder of the draw cycle and into the slow and fast rinse cycle. During this period of time the waste water pH falls below 5.0, the system is designed to divert the waste water stream to a dilution storage tank (using stored caustic drip feed for pH neutralization). Once complete with the slow and fast rinse cycles, the system is available to go back online producing partially de-alkalized and softened water effluent. The water stream is constantly monitored for volume of water processed and once the preprogrammed metered amount is exceeded, the resin is regenerated by repeating the above process. An alternative salt that can be used to form an acid to be used for regeneration is sodium sulfate which will create a dilute sulfuric acid (H2SO4) acid and sodium hydroxide (NaOH).

### Weak Base Anion Resin System

Weak base anion resin systems utilize a weak base or caustic (or diluted strong base) to regenerate the resin. Typical weak base anion resins are spherical beads made from macro-porous polystyrene crosslinked with divinylbenzene. The process exchanges sulfate and chloride ions for hydroxide ions. The regeneration process follows the standard regeneration protocol of backwash, brine or regenerant draw cycle, slow rinse, and fast rinse. It is during the regenerant draw cycle that the 10% sodium hydroxide generated from the salt splitter is used to regenerate the resin. The electrodialysis salt splitter system generates 10% NaOH (sodium hydroxide) based on a batch protocol to fill on storage tanks which are designed to store the product produced for use as needed during the regeneration cycle. Typical concentrations of caustic used is between 2-6 lbs of active sodium hydroxide per cubic foot of resin which is dosed into the regeneration process stream with a chemical pump proportional to make up flow rate for a time period of 30-120 minutes. The base is applied at a rate of 1-2 GPM per cubic foot of resin during regeneration to ensure proper regeneration contact time. In the final 10% of the regenerant draw cycle, the resin is regenerated. As a result, the draw cycle waste water rises above the industrial waste water discharge limit of 11.0 pH for the remainder of the draw cycle and into the slow and fast rinse cycle. During this period of time the waste water pH rises above 11.0, the system is designed to divert the waste water stream to a pH neutralization storage tank (using stored acid drip feed for pH neutralization). Once complete with the slow and fast rinse cycles, the system is available to go back on line producing partially sulfate and chloride removed effluent. The water stream is constantly monitored for volume of water processed and once the preprogrammed metered amount is exceeded, the resin is regenerated by repeating the above process. An alternative salt that can be used to form a base/caustic to be used for regeneration is sodium sulfate which will create a dilute sulfuric acid (H2SO4) acid and sodium hydroxide (NaOH) base.

Utilizing Embodiments of FIGS. 2 and 3 to minimize system corrosion rates.

Corrosion control in evaporative cooling water processes require the use of corrosion controlling agents. The primary factors that influence corrosion rates in evaporative cooling processes are: pH of the water, chloride and sulfate levels in the water, and the levels of oxidizing biocide chemistry in the cooling process. To help minimize the required amount of corrosion controlling chemistry agents needed to optimize corrosion control, pretreatment or treatment of the water to an ideal pH level, reducing the ion levels of chlorides and sulfates, and optimizing the level of oxidizing biocide in and to the system is beneficial. Real time corrosion monitoring control are installed to provide real time feedback to mixing valves and pumps to optimize the engineered water supplied to the evaporative cooling process. As real time corrosion monitoring sensors monitor corrosion rates, the controls system can modulate actuated blend valves to adjust the ratio of each water source to maintain optimal corrosion rates based on a combination of free oxidant residual, hardness, alkalinity, sulfates, and chloride levels.

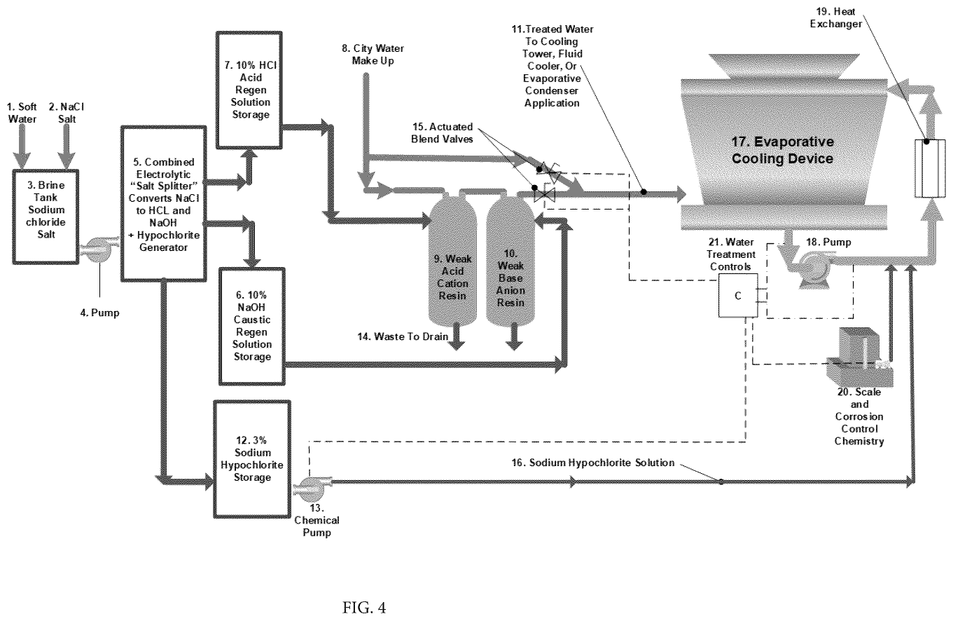

FIG. 4 illustrates in schematic form a system for addressing system corrosion utilizing the systems of FIGS. 2 and 3. The system includes the components within the cabinet/frame shown within border line 5 in FIG. 1. The components and their functions are described below.
1 Soft Water supply—This is the soft water make up supply used as the primary precursor for the reaction processes.
2. Sodium chloride or Potassium chloride salt—this is the other component that forms the primary reaction precursor for the reaction processes.
3. Brine Tank Saturation system—This tank is used to react the salt and water supply to create a saturated liquid brine solution that forms the primary reaction precursor for both chemical reactions.
4. Chemical brine pump—This pump supplies the precursor chemistry to the respective gas separator tanks.
5. Combination Electrolytic Salt Splitter and Sodium Hypochlorite generator—This shared component refers to the electrolytic generator process outlined in embodiment 1.
6. Liquid caustic storage tank—this storage tank is used to store the liquid caustic generated from the electrolytic processes.
7. Liquid hydrochloric acid storage tank—This storage tank is used to store the liquid hydrochloric acid solution generated from the electrolytic process and to be used in the downstream process.
8. City Water make up supply to resin tanks—this water source is the untreated source water that is to be treated and then used in the downstream process.
9. Weak Acid Cation Resin Tank—Weak acid cation resin used to remove hardness and alkalinity from the supply water source.
10. Weak Base Anion Resin Tank—Weak base anion resin used to remove sulfate and chloride ions from the water source.
11. Treated Water Effluent for use in downstream process—This is the final treated water to be used in downstream processes after being of an improved water quality.
12. Liquid sodium hypochlorite solution storage tank—This storage tank is used to store the liquid sodium hypochlorite solution to be used in the downstream process.
13. Liquid sodium hypochlorite solution pump—This pump is used to pump the liquid sodium hypochlorite solution to be used in the downstream process to act as a disinfectant.
14. Resin Drain Lines—These lines are used to pipe the regeneration flows from the resin regeneration processes to sewer drain.
15. Actuated blend valves—these valves are used to control the blend ratio of each water stream to blend the mixed water quality to meet the desired control parameters as feed water to the cooling process, thus therefore controlling the scale and corrosive nature of the water in the cooling system.
16. Sodium Hypochlorite Chemical Feed Line—This is the liquid sodium hypochlorite chemical feed supply line used to transport chemical from the storage tank to the treatment injection point.
17. Evaporative Cooling Device—This component is used to cool any process through the use of evaporation as a cooling medium—such as cooling tower, evaporative condenser, or fluid cooler.
18. Condenser Water pump—This pump provides water flow from the evaporative cooling equipment, through the heat exchanger, and returned back to the evaporative cooling equipment.
19. Heat Exchanger—The heat exchanger is used to transfer heat from one cooling medium to another cooling medium in the specific process application.
20. Scale and Corrosion Inhibitor Chemical and Storage Tank—This is the scale and corrosion inhibitor chemistry used in the evaporative cooling process to control mineral scale and corrosion in the condenser water process.
21. Water treatment controls—this control system is used to either measure the pH, conductivity, and oxidation reduction potential in the water and adjust the blending rate accordingly, and it is used to feed chemicals as a proportional control to water flow rate or direct measurement so that the feed of the scale and corrosion inhibitor and sodium hypochlorite is applied in a controlled manner. These control components are used to proportionally control the liquid chemical sodium hypochlorite feed into the resin effluent treated water.

Although the foregoing has been a description and illustration of specific embodiments of the subject matter, various modifications and changes thereto can be made by persons skilled in the art without departing from the scope and spirit of the invention.

1. A combined generator system, comprising:
an electrodialysis “salt splitting” (ESS) generator configured to convert sodium chloride salt or another salt into an acid and a caustic for use as regeneration solutions for weak acid cation, weak base anion, and/or strong base anion resin systems; and
an electro-generator configured to convert sodium chloride salt or another salt into an aqueous solution of a chlorine for treating make up water and/or recirculating water in a cooling tower, fluid cooler, or any evaporative cooling device; and
wherein said ESS generator and said electro-generator share a set of shared system components.

2. The system of claim 1, wherein said another salt includes sodium sulfate.

3. The system of claim 1, wherein said ESS generator and said shared system components including a brine tank saturation system, a hydrogen gas separator, and a liquid caustic storage tank.

4. The system of claim 1, wherein said chlorine is sodium hypochlorite, further comprising a system to combine treated make up water and said sodium hypochlorite solution.

5. The system of claim 1, wherein said chlorine is sodium hypochlorite, the system further comprising:
a sodium bromide solution storage tank for holding sodium bromide solution;
a sodium hypochlorite storage tank for holding said sodium hypochlorite;
a pump system for pumping said sodium hypochlorite and said sodium bromide solution into a feed line to produce hypobromous acid solution.

6. A corrosion control system for evaporative cooling water processes comprising the system of claim 4.

7. A corrosion control system for evaporative cooling water processes comprising the system of claim 5.

8. The system of claim 1, wherein said shared components includes a controller configured to control both said ESS generator and said electro-generator.

9. A system to produce treated water for cooling tower, fluid cooler or evaporative condenser installations, the system comprising:
a combined generator system as in claim 1;
a weak acid cation resin tank configured for removal of hardness and alkalinity from a supply water;
a weak base anion resin tank configured for removal of sulfate and chloride ions from the supply water;
wherein the supply water is processed through the weak acid cation and weak base anion resin tanks as resin treated supply water;
an acid regeneration solution storage tank for storing said acid and fluidically coupled to said weak acid cation resin tank for regeneration of the weak acid cation resin;
a caustic regeneration solution storage tank for storing said caustic and fluidically coupled to said weak base anion resin tank for regeneration of the weak base anion resin;
wherein the chlorine is sodium hypochlorite;
a sodium hypochlorite storage tank for storing the aqueous solution of sodium hypochlorite;
a pump system for controlling a feed of the aqueous solution of sodium hypochlorite through a feed line into a treatment injection point with the resin treated water to form a treated water effluent for the cooling tower, fluid tower or evaporative condenser installation, the pump system comprising a sodium hypochlorite pump connected to the sodium hypochlorite storage tank.

10. The system of claim 9, wherein the pump system further comprises:
a chemical feed sensor located downstream of the treatment injection point; and
a chemical feed controller responsive to the chemical feed sensor for controlling the sodium hypochlorite pump.

11. A system to produce treated water for cooling tower, fluid cooler or evaporative condenser installations, the system comprising:
a combined generator system as in claim 1;
a weak acid cation resin tank configured for removal of hardness and alkalinity from a supply water;
a weak base anion resin tank configured for removal of sulfate and chloride ions from the supply water;
wherein the supply water is processed through the weak acid cation and weak base anion resin tanks as resin treated supply water;
an acid regeneration solution storage tank for storing said acid and fluidically coupled to said weak acid cation resin tank for regeneration of the weak acid cation resin;
a caustic regeneration solution storage tank for storing said caustic and fluidically coupled to said weak base anion resin tank for regeneration of the weak base anion resin;
wherein the chlorine is sodium hypochlorite;
a sodium hypochlorite storage tank for storing the aqueous solution of sodium hypochlorite;
a sodium hypochlorite pump connected to the sodium hypochlorite storage tank for pumping the aqueous solution of sodium hypochlorite into a sodium hypochlorite feed line;
a sodium bromide storage tank for storing a liquid sodium bromide solution;
a sodium bromide solution pump connected to the sodium bromide storage tank;
a sodium bromide feed line connecting the sodium bromide solution pump to the sodium hypochlorite feed line at a feed line point upstream from a treatment injection point with the resin treated water, wherein the aqueous solution of sodium hypochlorite and the liquid sodium bromide solution form a hypobromous acid solution;
a hypobromous acid solution feed line connecting the feed line point to the treatment injection point;
wherein the resin treated water is combined with the hypobrous acid solution to form a treated water effluent for the cooling tower, fluid tower or evaporative condenser installation.

12. The system of claim 11, further comprising:
a chemical feed sensor located downstream of the treatment injection point; and
a chemical feed controller responsive to the chemical feed sensor for controlling the sodium hypochlorite pump and the sodium bromide solution pump.

13. A system to address corrosion in an evaporative cooling installation, comprising:
an evaporative cooling device;
a heat exchanger;
a condenser pump configured to pump cooling water from the evaporative cooling device through a water flow path to the heat exchanger and back into the evaporative cooling device; a combined generator system as in claim 1;
a weak acid cation resin tank configured for removal of hardness and alkalinity from a supply water;
a weak base anion resin tank configured for removal of sulfate and chloride ions from the supply water;
wherein the supply water is processed through the weak acid cation and weak base anion resin tanks as resin treated supply water for the evaporative cooling device;
an acid regeneration solution storage tank for storing said acid and fluidically coupled to said weak acid cation resin tank for regeneration of the weak acid cation resin;
a caustic regeneration solution storage tank for storing said caustic and fluidically coupled to said weak base anion resin tank for regeneration of the weak base anion resin;
wherein the chlorine is sodium hypochlorite;
a sodium hypochlorite storage tank for storing the aqueous solution of sodium hypochlorite;
a sodium hypochlorite pump for controlling a feed of the aqueous solution of sodium hypochlorite through a sodium hypochlorite feed line into a sodium hypochlorite treatment injection point with the cooling water to form a treated water effluent for the evaporative cooling device.

14. The system of claim 13, further comprising:
a chemical storage tank holding scale and corrosion inhibitor chemicals;
a chemical feed line connecting the chemical storage tank to a chemical injection point with the cooling water;
a water treatment controller configured to measure parameters of the cooling water and control the sodium hypochlorite pump, the condenser pump and a valve system to control flow of the resin treated water to the evaporative cooling device and the feed of the sodium hypochlorite and the scale and corrosion inhibitor chemicals into the cooling water.
